(19) United States
(12) Patent Application Publication
(10) Pub. No.: US 2013/0047268 A1
(43) Pub. Date: Feb. 21, 2013

(54) Methods for Using Biometric Authentication Methods for Securing Files and for Providing Secure Access to Such Files by Originators and/or Authorized Others

(71) Applicant: Vacit Arat, La Canada - Flintridge, CA (US)

(72) Inventor: Vacit Arat, La Canada - Flintridge, CA (US)

(73) Assignee: Sigza Authentication Systems

(21) Appl. No.: 13/558,300

(22) Filed: Jul. 25, 2012

Related U.S. Application Data
(63) Continuation-in-part of application No. 13/314,059, filed on Dec. 7, 2011.
(60) Provisional application No. 61/511,535, filed on Jul. 25, 2011.
(60) Provisional application No. 61/511,535, filed on Jul. 25, 2011.
(60) Provisional application No. 61/511,532, filed on Jul. 25, 2011.
(60) Provisional application No. 61/488,692, filed on May 20, 2011.
(60) Provisional application No. 61/438,631, filed on Feb. 1, 2011.
(60) Provisional application No. 61/420,729, filed on Dec. 7, 2010.

(51) Int. Cl. G06F 21/00

(52) U.S. Cl. 726/28

(57) ABSTRACT

Embodiments are directed to apparatus, methods and systems for locking data or program files and for allowing access to such files only by individuals given authorization and wherein the identity of locking or accessing individuals is provided by comparison of collected inertial information associated with providing a signature with information stored about the particular individuals. In a first embodiment two primary components work together to provide collection of inertial data (and potentially other data) and then comparing of the collected data to stored data to provide an authentication or identification assessment. The first of these components is a SigzaPen device for acquiring data while the second is a remote Signature Processing Center (“SPC”) wherein these two components are capable of communicating directly or indirectly with each other.

### RELATED APPLICATIONS

This application claims benefit of U.S. Provisional Patent Application No. 61/511,535, filed Jul. 25, 2011 and this application is a CIP of U.S. patent application Ser. No. 13/314,059, filed Dec. 7, 2012 which in turn benefit of U.S. Provisional Patent Application Nos. 61/511,535, filed Jul. 25, 2011; 61/511,532, filed Jul. 25, 2011; 61/488,692, filed May 31, 2011; 61/438,631, filed Feb. 1, 2011; and 61/420,729, filed Dec. 7, 2010, respectively. The teachings of the '535, '532, and '059 applications are incorporated herein by reference as if set forth in full herein.

### FIELD OF THE INVENTION

The present invention relates generally to the field of biometric authentication methods, apparatus and systems and more particularly to such methods, apparatus, and systems used for securing files and providing access to such files (e.g. in the form of individual data files, individual program files, groups of files, folders, directories, and disks)

### BACKGROUND OF THE INVENTION

Several biometric identification & authentication techniques are in use today for security and access control applications. These include fingerprint identification, retinal scan, iris scan, face recognition, hand geometry, palm vein authentication, voice analysis, and finally, signature analysis. Common applications of these tools include fingerprint scanners in laptop computers; surveillance cameras which use face recognition software; retinal and palm scanners for physical access to buildings, etc.

While there are many advantages to biometric authentication, several factors have limited its proliferation into ubiquitous use by consumers:
Some of the methods can be relatively intrusive; others can be impractical, cumbersome and/or expensive.
Traditionally, gathering and using detailed biometric information has been the domain of governmental institutions (military, police, customs, etc.); and has been viewed as a loss of privacy and freedom in that the information can be used to track a person's movements without their knowledge or consent. Same concerns apply to companies that have access to biometrics on their customers and may misuse the data.
Consumers are concerned about how the collected data, especially if it is electronic, will be stored and safeguarded.

As a result, biometric identification and authentication techniques have not been popular in consumer transactions, over the internet or otherwise. Instead, “secure” connections and password-based transactions have dominated internet transactions, and physical ID checks have been used at point-of-sale locations. Such transactions include entry into social and business networking sites, credit card transactions, e-mail access, VPN access, medical record access, opening password-protected files and databases, etc.

Various needs exist for creating files, sharing files, purchasing products and services (i.e. consumers), selling products and providing services (i.e. merchants), and others for improved identification and/or authentication of asserted authorization or identity to allow a vast array of secured transactions (e.g. commercial and non-commercial transactions and interactions) to occur with improved confidence in the identity of a transacting party or parties or otherwise provide transaction authentication without necessarily exchanging information that can be stolen or misused by others.

### SUMMARY OF THE INVENTION

It is an object of some embodiments of the invention to provide an improved method for locking computer files or groups of files (e.g. folders, hard disk access, etc.), opening such locked files, and possibly transmitting such files to others while maintaining a desired level of file security.

It is an object of some embodiments of the invention to provide an improved system or apparatus for locking computer files or groups of files (e.g. folders, hard disk access, etc.), opening such locked files, and possibly transmitting such files to others while maintaining a desired level of file security.

Other objects and advantages of various embodiments of the invention will be apparent to those of skill in the art upon review of the teachings herein. The various embodiments of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

In a first aspect of the invention, a method for allowing the locking of a file or access to a file by authenticating a signature of a first party wherein the first party uses a signature capture and transmission device, includes: (a) initiating locking of a file or access to a locked file by the first party, wherein the first party has access to a signature capture and transmission device that comprises at least one inertial measurement sensor, control electronics, and transmission capability to send selected captured signature information, directly or indirectly, to a remote signature processing center; (b) sending, directly or indirectly, selected identification information about a request to lock or open a file to the remote signature processing center; (c) sending, directly or indirectly, information from the remote signature processing center to the first party, an indication that signature capture may begin; (d) undergoing a series of signature providing motions by the first party while holding the signature capture and transmission device such that the device undergoes a series of device motions at least a portion of which are captured by the device using the at least one inertial measurement sensor; (e) sending, directly or indirectly, selected signature information concerning the captured device motions corresponding to the signature providing motions to the remote signature processing center, wherein the sending time is selected from a group consisting of (1) starting prior to completion of the signature providing motions and (2) starting after completion of the signature providing motions; (f) receiving the sent selected signature information at the remote signature processing center and processing the received information to produce relevant authorization information based on authentication confirmation or rejection wherein the processing includes a comparison of information selected from the group consisting of sent information and information derived from the sent information with template information associated with the signature capture and transmission device as previously provided to the signature processing center; and (g) sending relevant information back to the first party that either denies locking or access based on authentication rejection or that allows for locking or access based on authentication confirmation that results from the processing of step (f).

Numerous variations of the first aspect of the invention are possible and include, for example: (1) the sending of information from the remote signature processing center to the first party via the signature capture and transmission device; (2) the relevant authentication information includes identification information; (3) the locking or access is access; (4) the locking or access is locking; (5) the locking or access is both locking and access; (6) the file includes a plurality of files; (7) the file includes a data file; (8) the file includes an executable file; (9) the authentication requires a plurality of different signatures; (10) the first party includes a plurality of individuals and each must provide a signature; (11) the first party includes a plurality of individuals and each must provide a signature and the signatures must be made in a preset order; (12) the locking or access is locking and the locking is performed in a series of successive locks; (13) the locking or access is access and the access is only provided by reversing the order of a series of successively applied locking signatures; (14) the signature processing center is remote relative to the computer holding the file; (15) signature processing center is local relative to the computer holding the file; (16) the signature process center is local and is the local signature processing center is located on a private network that is common to a network on which the computer holding the file is located; (17) the signature processing center is remote and is connected to the computer holding the files over an open network (e.g. the internet or a telephone network); (18) the remote signature processing center remote and is connected to the computer holding the files over an open network but is connected via a virtually private network (e.g. the internet or telephone network); and (19) the comparison further includes use of non-inertial data; (20) combinations of two or more of these variations into one or more functional methods.

In a second aspect of the invention, a method for allowing the locking of a file or access to a file by authenticating a signature of a first party wherein the first party uses a signature capture and transmission device, includes: (a) initiating locking of a file or access to a locked file by the first party, wherein the first party has access to a signature capture and transmission device that comprises at least one inertial measurement sensor, control electronics, and transmission capability to send selected captured signature information, directly or indirectly, to a signature processing center; (b) sending, directly or indirectly, selected identification information about a request to lock or open a file to the signature processing center and undergoing a series of signature providing motions by the first party while holding the signature capture and transmission device such that the device undergoes a series of device motions at least a portion of which are captured by the device; (c) receiving the sent information at the signature processing center and processing the received information to produce relevant authorization information based on authentication confirmation or rejection, wherein the processing comprises a comparison of information selected from the group consisting of sent information and information derived from the sent information with template information associated with the signature capture and transmission device as previously provided to the signature processing center; and (d) sending relevant information back to the first party that either denies locking or access or that allows for locking or access based on the results of the processing of step (c).

Numerous variations of the second aspect of the invention are possible and for example include those noted above in association with the first aspect of the invention.

In a third aspect of the invention a method for allowing a second party, different from a first party, to access a file locked by the first party wherein the second party uses a signature capture and transmission device, includes: (a) initiating a file access request for the second party, wherein the second party has access to a signature capture and transmission device that comprises at least one inertial measurement sensor, control electronics, and transmission capability to send selected captured signature information, directly or indirectly, to a signature processing center; (b) sending, directly or indirectly, selected identification information about the request to the signature processing center; (c) sending, directly or indirectly, information from the signature processing center to the second party an indication that signature capture may begin; (d) undergoing a series of signature providing motions by the second party while holding the signature capture and transmission device such that the device undergoes a series of device motions at least a portion of which are captured by the device using the at least one inertial measurement sensor; (e) sending, directly or indirectly, selected signature information concerning the captured device motions corresponding to the signature providing motions to the signature processing center, wherein the sending time is selected from a group consisting of (1) starting prior to completion of the signature providing motions and (2) starting after completion of the signature providing motions; (f) receiving the sent selected signature information at the signature processing center and processing the received information to produce relevant authorization information based on authentication confirmation or rejection wherein the processing includes a comparison of information selected from the group consisting of sent information and information derived from the sent information with template information associated with the signature capture and transmission device as previously provided to the signature processing center; and (g) sending relevant information back to the second party that either denies access based on authentication rejection or that allows for access based on authentication confirmation the results from the processing of step (f).

Numerous variations of the third aspect of the invention are possible and include, for example: (1) the signature processing center being a remote signature processing center; (2) the sending of information from the signature processing center to the second party via the signature capture and transmission device; (3) the relevant authentication information includes second party identification information; (4) the first party is sent a communication informing the first party that the second party has been granted access to the file; (5) prior to sending relevant information back to the second party that allows access, the first party is notified of the second party's attempted access and successful authentication after which the first party is required to then provide final access approval using a signature capture and transmission device after which the file is sent to the second party; (6) the file includes a plurality of files; (7) the file includes a data file; (8) the file includes an executable file’ (9) the authentication requires a plurality of different signatures; (10) the second party includes a plurality of individuals and each must provide a signature; (11) the second party includes a plurality of individuals and each must provide a signature and the signatures must be made in a preset order; (12) the locking or access is locking and the locking is performed in a series of successive locks; (13) the signature processing center is remote relative to the computer holding the file; (14) signature processing center is local relative to the computer holding the file; (15) the signature process center is local and is the local signature processing center is located on a private network that is common to a network on which the computer holding the file is located; (16) the signature processing center is remove and is connected to the computer holding the files over an open network (e.g. the internet or a telephone network); (17) the remote signature processing center remote and is connected to the computer holding the files over an open network but is connected via a virtually private network (e.g. the internet or telephone network); (18) the comparison further includes use of non-inertial data; and (19) combinations of two or more of these variations into one or more functional methods.

In a fourth aspect of the invention, a method for allowing a second party, different from a first party, to access a file locked by the first party wherein the second party uses a signature capture and transmission device, includes: (a) initiating an file access request for the second party, wherein the second party has access to a signature capture and transmission device that comprises at least one inertial measurement sensor, control electronics, and transmission capability to send selected captured signature information, directly or indirectly, to a signature processing center; (b) sending, directly or indirectly, selected identification information about the request to the signature processing center and undergoing a series of signature providing motions by the second party while holding the signature capture and transmission device such that the device undergoes a series of device motions at least a portion of which are captured by the device; (c) receiving the sent selected information at the signature processing center and processing the received information to produce relevant authorization information based on authentication confirmation or rejection, wherein the processing comprises a comparison of information selected from the group consisting of sent information and information derived from the sent information with template information associated with the signature capture and transmission device as previously provided to the signature processing center; and (d) sending relevant information back to the second party that either denies access based on authentication failure or that allows for access based authentication confirmation resulting from the processing of step (c).

Numerous variations of the second aspect of the invention are possible and for example include those noted above in association with the third aspect of the invention.

In a fifth aspect of the invention, a system, includes: (a) a plurality of devices for capturing motions associated with signatures using inertial data for the purpose of providing signature authentication or identity verification for allowing the locking of files or access to locked files; and (b) a signature processing center that is remove from the devices for capturing the motions.

In a sixth aspect of the invention, a system, includes: (a) a plurality of devices for capturing associated with signatures using inertial data for the purpose of providing signature authentication for file locking and/or file access by either an originating party and/or a receiving party wherein the receiving party may be the same as the originating party or different from the originating party and (b) a remote signature processing center for deriving authentication information based at least in part on received inertial data and data previously recorded.

Multiple variations of the fifth and sixth aspects of the invention are possible and include, mutatis mutandis, the variations noted in association with the above noted aspects of the invention.

Other aspects of the invention will be understood by those of skill in the art upon review of the teachings herein. Other aspects of the invention may involve combinations of the above noted aspects of the invention. These other aspects of the invention may provide other configurations, structures, functional relationships, processes, and systems that have not been specifically set forth above.

### BRIEF DESCRIPTION OF THE DRAWINGS

FIG. 1 provides an example of a method for locking and unlocking files using a SigzaPen™.

FIG. 2 provides an example method for locking, sending and unlocking files using a SigzaPen™.

### DETAILED DESCRIPTION OF PREFERRED EMBODIMENTS

In a first embodiment of the invention two primary components work together to provide collection of inertial data (e.g. accelerations, decelerations, twists, and/or turns of a capture or recording component), and potentially other data (e.g. when a capture or recording component makes contact with, or is in proximity to a surface, when the component is away from the surface) and comparison of the collected data to stored data to provide authorization, authentication, or identification assessment which results in authorization to lock a file (i.e. create a secured file), authorization to unlock a file (i.e. to open a locked file), or to proceed to a next step in a multi-step process of securing a file or for obtaining access to the file. The locking and unlocking may involve merely toggling data bits that provide/allow for rights to lock or unlock, may insert or remove password information into security features pre-existing in the file (and/or program intended to run the file—e.g. password protection as provided in some Microsoft products), addition or removal of initial, terminal, or intermediate data into the file that makes the file difficult or impossible to open, rearrangement of file bits, encryption of file contents, or the like. The first of these components is a signature capture device (e.g. a SigzaPen™ device) for acquiring data (i.e. capturing and possibly recording such data) while the second is a remote Signature Processing Center (“SPC”) capable of analyzing and making use of the captured data wherein these two components or system elements are capable of communicating directly or indirectly with each other. In the present embodiment the SPC is remote (i.e. not directly linked to the signature capture device or connected to it via an intranet-like network) but connected to it via an independent network (e.g. the internet or a phone network). In some embodiment variations, the SPC may be local (e.g. connected directly to the signature capture device via a hard wire or in a wireless manner or via an intranet or other closed network) while in other variations the SPC may be embedded in the device signature capture device itself.

In this embodiment of the invention, enhanced information (e.g. actual or alternatively defined signature information) is gathered and analyzed to readily provide unique and significantly enhanced authorization, authentication, and/or identification information that may be used to provide enhanced discrimination such that file contents may be secured or accessed by only authorized individuals. This embodiment and many of its variations provide a practical, safe, and highly personalized system to integrate biometric authentication into file security applications (e.g. to limit access to particular files, allow execution of particular programs, allow access to file groups, e.g. allow access to particular hard disks or servers).

The method of this first embodiment of the invention, as noted above, makes use of the two primary components in combination to provide a distributed system of hardware, software, and communication tools which collect, analyze and communicate data related to the act of signing one's signature or other biometric recordable action, and provides authentication and/or identification information to designated parties to allow improved file security (e.g. program file execution access or data file access). This embodiment of the invention relies on the fact that the way that individuals sign their signatures (e.g. one or more of relative position, speed, acceleration, deceleration, twists and turns of a signature capture device is extremely unique to an individual. It is believed that such measurement and analysis of such parameters may yield identification or authentication results that are significantly more difficult to duplicate than that obtained from other types of biometric methods. In variations on this embodiment, selected parameters from the above exemplary listing may be used alone or in combination with each other or in combinations with other information to yield authentication or identification assessments.

It is further believed that each instant of signing is unique and thus the same individual will not duplicate his/her signature 100% from iteration to iteration and as such in some variations of the embodiment, exactness of captured signature parameters may be used to yield authentication or identification rejection while “close enough” may be used to provide authentication or identification. Therefore, in numerous variations of the present embodiment, the following steps may be used in providing signature identification or authentication: (1) precisely recording parameters associated with a unique act of signing a signature, or performing some other measurable largely repeatable, and difficult to duplicate set of movements, for a given transaction or third party; (2) transmitting, directly or indirectly, e.g. via the internet, these recorded parameters, selected portions of these parameters, or a coded version (e.g. an encrypted version) of these parameters or selected portions of these parameters to a remote signature processing center; (3) analysis at the signature processing center of received information, e.g. based on an original act of signing, based on a history of signatures, and/or other information; (4) direct or indirect transmittal, of the authentication or identification conclusion to allow lock down or access to one or more selected files (e.g. data files or programs) This process can be used to provide a highly secured method of authentication and/or identification for use in locking down or allowing access to computer data and/or program files. In addition to the recording step, the transmitting step, the analysis step, and the conclusion providing step, the process may include additional steps such as the entering of a provided locking code or access code that is also required for securing or opening a file. The locking may include complete or partial file encryption or other data manipulation while the access may include an opening of a file so it may be viewed, manipulated, or executed, which may or may not be preceded by a previous unlocking or decryption step of a previously locked or encoded file. In other embodiment variations, the FLUSP program (described below) that is being executed by the originator or by an accessing user may provide for, with or without further input, file locking or file access.

SigzaPen™ Data Capture and Transmission Device

As noted above, one component of the first embodiment is a signature capture device which is sometimes known as a SigzaPen™ which individuals may use to record and send relevant signature data to the signature processing center. An exemplary SigzaPen may have an appearance similar to that of a normal pencil or pen or some other handheld device (e.g. a smart phone, wallet, eye glasses, key, key chain, small flash light, or the like and may include a variety of features/elements. These features or elements may include for example, one or more of: (1) inertial sensors which may consist of one or more accelerometers and/or one or more gyroscopes which measure changes in translational or rotational motion; (2) a pressure sensor or one or more other sensors (e.g. optical sensors, proximity sensors, or the like) placed at or close to a tip of the SigzaPen which may be used in providing contact or proximity information relative to a writing surface; (3) one or more other sensors that may be used to provide for additional information about SigzaPen movement (e.g. one or more cameras) that can focus on a surface being traversed by the SigzaPen to provide a visual or other optical recording of images that result from the movement or which provide for landmark recording as the SigzaPen moves across a surface; (4) electronic circuitry that processes the data retrieved from the inertial and optional sensor(s) and transmits or sends the information to the signature processing center; and (5) a button or other trigger mechanism to depress or touch, respectively (e.g. to hold while providing a signature and to release when the signing is completed). Capturing motion information about the movements of a mobile device and some uses for such information are set forth in U.S. published patent application no. US2010/0214216, published Aug. 26, 2010, by Steven S. Nasiri, et al., and entitled “Motion Sensing and Processing on Mobile Devices”. The teachings in this referenced published application are incorporated herein by reference as if set forth in full herein.

Signature Processing Center (SPC)

The SPC is typically a remote server/computer or group of servers/computers that is/are connected to a network (e.g. to the internet or a telephone network) to allow direct or indirect communication with a SigzaPen, with software operating on the device holding the file or files, and with others to whom files or file access may be given The SPC is where, in this first embodiment, that the signature identification and/or authentication data processing takes place for either locking or unlocking a file or group of files (e.g. for granting rights to secure files and for granting rights to access files). The SPC, for example, may receive access requests for files or programs from other SigzaPen holders and may provide authentication and identification that allows or denies access to certain files or programs (e.g. it may provide decryption information necessary to view or use the files or programs) via information provided to special software running on the requestor's computer or other electronic device. The SPC may also record and update original signatures with each attempted authentication or identification and may send notices to SigzaPen users (e.g. to the person who locked the file) or provide user retrievable logs of authentication or identification attempts. In some embodiment variations, the SPC may capture and retain information about those individuals that have access to a file and the SPC may compare such retained information, for a given locked file, with the identity of an individual attempting to access the file.

Locking and Unlocking Files

Files of all kinds (e.g. documents, spreadsheets, picture files, video files, database files, executable or program files, etc.), or groups of such files, which may or may not be in a folder, can be locked using SigzaPen authorization conducted over the internet, and can only be unlocked by authorized parties who use their SigzaPens to sign and authenticate themselves.

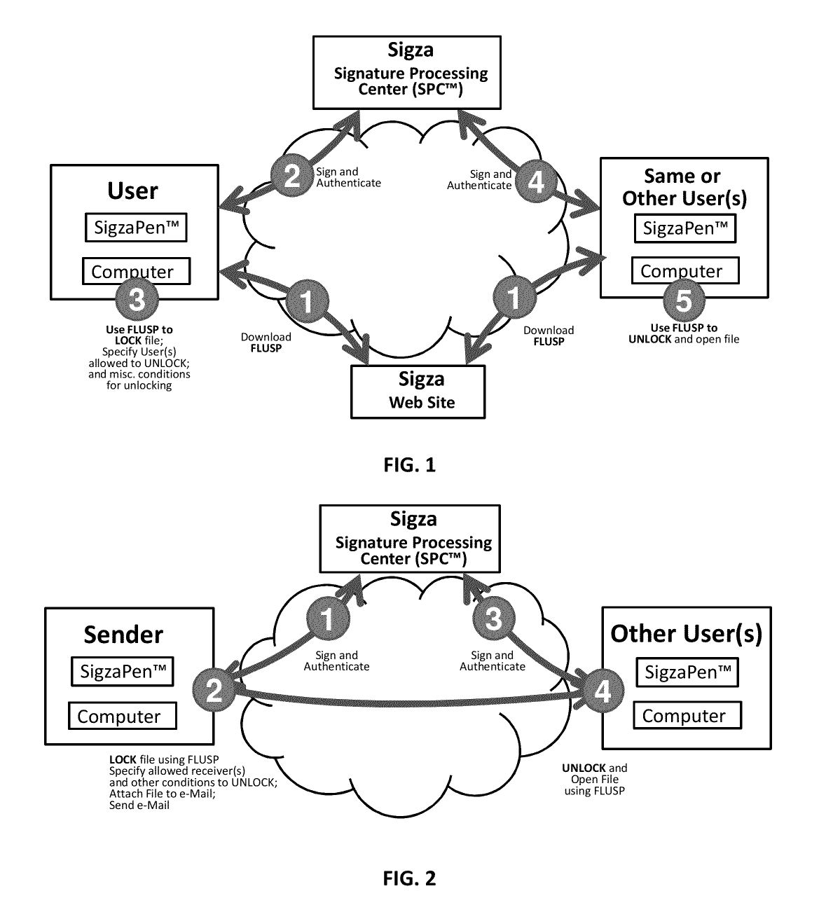

FIG. 1 provides an example embodiment for locking and unlocking files while FIG. 2 provides an example embodiment for adding file transfer to the process.

In the embodiment of FIG. 1, users who would like the ability to lock and unlock files need to first do the following: (1) Register to become a SigzaPen user by creating an account with the SPC and providing required information; and (2) Download software from the SPC, or associated website, as indicated in STEP 1 of FIG. 1. As indicated, a User needs to download a File Locking & Unlocking Software Program (“FLUSP”) from an appropriate site (e.g. the Sigza Web Site as illustrated in the FIG. 1) via the internet or other network (represented by the cloud in FIG. 1).

When a user (as in “User” in FIG. 1) is ready to lock a file, he/she may perform the following steps: (1) running the FLUSP application on his/her computer or other electronic device; (2) specifying the file(s), directory or directories, hard disk or hard disks, server or servers, to be locked; (3) specifying the party(s) authorized to unlock the file(s) by entering their User ID(s) and any other identifying information as may be necessary and by providing any other information or criteria that may be appropriate (e.g. those set forth below for unlocking files); (4) ordering the locking process to start (e.g. push “Lock Now” or a similar button on the user interface) which sends a signal to the SPC to request SigzaPen authentication; (5) the SPC sending a request to the user's SigzaPen to sign; (6) the user signing and data being passed to the SPC; (7) the SPC running authentication algorithms (e.g. which may be based on data received from one or more inertial sensors, optical sensors, pressure sensors, touch sensors, during the signature capture process which are compared to previously recorded information (e.g. that was provided during sign up or thereafter); (8) if the signature is authenticated, the SPC provides an indication to the FLUSP to allow locking to begin and possibly to the user, so that the FLUSP alone or in combination with further user action can provide for locking the file(s); and (9) the FLUSP locks the file(s).

In this embodiment the locked file may also have a file type (e.g. .sig) that is different from the original file type (.doc, .ppt, .jpg, .exe, etc.). Such SigzaPen-locked files may be treated the same way as most other files. For example, they may be stored in one's computer or a networked location, hot-linked inside of documents, tweets, texts, websites, etc., so users can be directed to them easily, be further encrypted, zipped, etc., be attached to e-mails (an example of the steps that one goes through to send and receive e-mails with SigzaPen-locked files is illustrated in FIG. 2). The only difference between SigzaPen-locked files and other files is that they can only be opened by the party(s) authorized by the person who locked them in the first place. The process of requesting locking and locking of the files is illustrated by steps 2 and 3 in FIG. 1.

In this first embodiment, when the same or any other user (as in “Same or Other User(s)” in FIG. 1) is ready to unlock a file, he/she may take the following steps: (1) the user attempts to directly open the file(s), e.g. by clicking on the file icon/name/hotlink, etc., which prompts the FLUSP to execute initiating an unlock or open request to the PSC or the user opens the FLUSP and then from the FLUSP attempts to open a file which initiates the unlock or open request; (2) optionally, upon request by the FLUSP, the user enters e.g. the SigzaPen User ID and/or any other credentials as may be required by the SigzaPen authentication protocol; (3) optionally, if not automatically initiated by the FLUSP, the user indicates readiness for the unlocking process to begin (e.g. by pushing the “Unlock Now” or a similar button on the user interface) which sends a signal to the SPC to initiate an authentication; (4) the SPC sends a request to the user's SigzaPen to sign or indicates readiness to receive signature information from the SigzaPen; (5) the user then make his/her signature; (6) the SPC runs the authentication algorithms; (7) if the signature is authenticated and the identified user is authorized to open the file, the FLUSP causes the file to unlock; and (7) optionally, if not automatically initiated, the user opens or executes the unlocked file or program or otherwise takes appropriate action with the unlocked file (e.g. copies it, moves it to a new location, etc.). The process of unlocking files is indicated in FIG. 1 by steps 4 and 5.

In variations of this first embodiment, when a user locks the file(s), he/she can specify parameters/conditions for the file(s) to be unlocked. These may include but are not limited to: (1) specification of the User ID(s) of the people who are authorized to unlock the file(s) by using their SigzaPen's; (2) options on whether each person on the list may unlock the file(s) individually, or some or all of them need to have gone through the unlocking process before the file(s) can be finally unlocked and available to any of them; (3) time limitations/windows for being able to unlock the file(s), (4) geographical locations of recipients eligible to unlock the file(s) (these may be determined by GPS information supplied, for example, by the SigzaPen at the time of the unlocking attempt; (5) IP addresses of the computers eligible to unlock the file(s); (6) number of attempts allowed to unlock the file(s) and possible lock out periods if excessive failed attempts are made; (7) whether or not the user wants to know when the files are actually unlocked, and his/her preferences on how he/she can be informed of this event, such as via a message sent from the SPC back to the “locking” user, logging the time and other details of the event; and/or (8) specifying that when others are attempting to unlock the file, the originating user also needs to authorize the opening using his/her SigzaPen at the time, or only after the user finally authorizes it at his/her convenience.

FIG. 2 illustrates a variation of the first embodiment wherein a locked file is actually transferred to a third party. The process of FIG. 2 has a great deal in common with the process of FIG. 1 but assumes that the “originating” or “locking” user (i.e. sender) and the “receiving” user already have accounts with the SPC and already have installed the FLUSP software. In this second embodiment, the originating user locks the file or files (step 1) transfers the file or files to another user (step 2) who requests authentication to the open the file or files (step 3) and then opens the file (step 4).

Numerous variations of the first and second embodiments exist. In some variations a single copy of the locked document exists and is accessed over a closed or open network by those with appropriate authorization. In some variations, the file or files may only be accessed from a single computer terminal by different users using different SigzaPens and or different SigzaPen signatures. In some variations the locking may encrypt the file or files while in other variations it may only inhibit the opening of files. In some embodiment variations, the originating user need not necessarily use a SigzaPen to lock the file but need only indicate in some manner the identity of those having access rights. In some embodiments, the originating user will be provided automatically with access rights while in others such rights may need to be explicitly given. In some embodiment variations, some files may be locked with multiple levels of SigzaPen locking or other forms of file locking (e.g. password protection) or encryption password encryption (i.e. serial locking using the same or different locking parameters at each level and thus requiring the same or different opening criteria at each level. In some embodiments of sequential locking may require unlocking in a reversed order to how locking originally occurred while in other embodiments the locking and unlocking order may be the same.

Features of a handheld (e.g. smart phone) device that can be used as a SigzaPen are described in a concurrently filed patent application having docket number PASP-005US-A, by Vacit Arat, and entitled “Smart Phone Writing Method and Apparatus”. This referenced application is incorporated herein by reference. The features and methods of this incorporated application may be used in combination with the embodiments and variations described herein to create even further embodiments.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims presented hereafter.

I claim:

1. A method for allowing a second party, different from a first party, to access a file locked by the first party wherein the second party uses a signature capture and transmission device, the method comprising:
(a) initiating a file access request for the second party, wherein the second party has access to a signature capture and transmission device that comprises at least one inertial measurement sensor, control electronics, and transmission capability to send selected captured signature information, directly or indirectly, to a signature processing center;
(b) sending, directly or indirectly, selected identification information about the request to the signature processing center;
(c) sending, directly or indirectly, information from the signature processing center to the second party an indication that signature capture may begin;
(d) undergoing a series of signature providing motions by the second party while holding the signature capture and transmission device such that the device undergoes a series of device motions at least a portion of which are captured by the device using the at least one inertial measurement sensor;
(e) sending, directly or indirectly, selected signature information concerning the captured device motions corresponding to the signature providing motions to the signature processing center, wherein the sending time is selected from a group consisting of (1) starting prior to completion of the signature providing motions and (2) starting after completion of the signature providing motions;
(f) receiving the sent selected signature information at the signature processing center and processing the received information to produce relevant authorization information based on authentication confirmation or denial wherein the processing comprises a comparison of information selected from the group consisting of sent information and information derived from the sent information with template information associated with the signature capture and transmission device as previously provided to the signature processing center; and
(g) sending relevant information back to the second party that either denies access based on authentication rejection or that allows for access based on authentication confirmation the results from the processing of step (f).

2. The method of claim 1 wherein the file comprises a plurality of files.

3. The method of claim 1 wherein the file comprises a file selected from the group consisting of: (1) a data file, and (2) an executable file.

4. The method of claim 1 wherein the first party is sent a communication informing the first party that the second party has been granted access to the file.

5. The method of claim 1 wherein the second party comprises a plurality of individuals.

6. The method of claim 1 wherein the locked file is transferred to the second party over a network.

7. The method of claim 1 wherein prior to sending relevant information back to the second party that allows access, the first party is notified of the second party's attempted access and successful authentication after which the first party is required to then provide final access approval using a signature capture and transmission device after which the file is sent to the second party.

8. The method of claim 1 wherein prior to sending allowing access, multiple signature authentications must be sought and received.

9. The method of claim 1 wherein an original file is locked a plurality of successive times with each locking producing a successively locked file and wherein the allowing of access requires obtaining access to the successively locked files using a step selected from the group consisting of (1) the unlocking is performed in an order corresponding to a reverse of a locking order; (2) the unlocking is performed by providing at least two different signatures; (3) the unlocking is performed by at least two different individuals that provide their own signatures.

10. The method of claim 1 wherein the signature process center is remote relative to the location of the file.

11. A method for allowing a second party, different from a first party, to access a file locked by the first party wherein the second party uses a signature capture and transmission device, the method comprising:
(a) initiating an file access request for the second party, wherein the second party has access to a signature capture and transmission device that comprises at least one inertial measurement sensor, control electronics, and transmission capability to send selected captured signature information, directly or indirectly, to a signature processing center;
(b) sending, directly or indirectly, selected identification information about the request to the signature processing center and undergoing a series of signature providing motions by the second party while holding the signature capture and transmission device such that the device undergoes a series of device motions at least a portion of which are captured by the device;
(c) receiving the sent selected information at the signature processing center and processing the received information to produce relevant authorization information based on authentication confirmation or rejection, wherein the processing comprises a comparison of information selected from the group consisting of sent information and information derived from the sent information with template information associated with the signature capture and transmission device as previously provided to the signature processing center; and
(d) sending relevant information back to the second party that either denies access based on authentication failure or that allows for access based authentication confirmation resulting from the processing of step (c).

12. The method of claim 11 wherein the file comprises a plurality of files.

13. The method of claim 11 wherein the file comprises a file selected from the group consisting of: (1) a data file, and (2) an executable file.

14. The method of claim 11 wherein the first party is sent a communication informing the first party that the second party has been granted access to the file.

15. The method of claim 11 wherein the second party comprises a plurality of individuals.

16. The method of claim 11 wherein the locked file is transferred to the second party over a network.

17. The method of claim 11 wherein prior to sending relevant information back to the second party that allows access, the first party is notified of the second party's attempted access and successful authentication after which the first party is required to then provide final access approval using a signature capture and transmission device after which the file is sent to the second party.

18. The method of claim 11 wherein prior to sending allowing access, multiple signature authentications must be sought and received.

19. The method of claim 11 wherein an original file is locked a plurality of successive times with each locking producing a successively locked file and wherein the allowing of access requires obtaining access to the successively locked files using a step selected from the group consisting of (1) the unlocking is performed in an order corresponding to a reverse of a locking order; (2) the unlocking is performed by providing at least two different signatures; (3) the unlocking is performed by at least two different individuals that provide their own signatures.

20. The method of claim 11 wherein the signature process center is remote relative to the location of the file.
